(19) United States
(12) Patent Application Publication
(10) Pub. No.: US 2004/0044745 A1
(43) Pub. Date: Mar. 4, 2004

(54) Method, apparatus, and computer program for servicing viewing record of contents

(75) Inventors: Seiya Shimizu, Kawasaki (JP); Asako Kitaura, Kawasaki (JP); Motoo Masui, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/638,487

(22) Filed: Aug. 12, 2003

(30) Foreign Application Priority Data
Aug. 30, 2002 (JP) 2002-255740

(51) Int. Cl. G06F 15/16

(52) U.S. Cl. 709/217

(57) ABSTRACT

An apparatus that services a viewing record of contents includes a contents converter for a viewing record service server. The viewing record service server receives a multimedia contents distribution request from a certain user viewing terminal, and inquires an external viewing record managing server about a viewing record of multimedia contents at a user viewing terminal. The contents converter obtains the multimedia contents from a certain multimedia contents server, converts the multimedia contents into post-conversion contents that reflect the viewing record of the multimedia contents, and distributes the post-conversion contents to the user viewing terminal.

### BACKGROUND OF THE INVENTION

1) Field of the Invention

The present invention relates to a technology for allowing online management of a viewing record of multimedia contents without using a dedicated browser or dedicated contents.

2) Description of the Related Art

In recent years, in association with the utilization of broadband of networks, services for distributing multimedia contents that display motion pictures, audios, texts, and still pictures in combination have become widely available.

These multimedia contents have a play time of several minutes to several tens of minutes, and are provided to viewing terminals at a user side (“user viewing terminal”) through downloading or streaming. These multimedia contents are used in the entertainment field such as distribution of sports videos and moving pictures, and the education field such as distance education based on video on demand.

FIG. 13 is a block diagram of a conventional multimedia contents distributing system 50. This multimedia contents distributing system 50 has a function of distributing multimedia contents to users according to requests from the users, and a function of managing a viewing record of each user viewing the multimedia contents.

The multimedia contents distributing system 50 includes a user viewing terminal 10 at which a user views multimedia contents, a contents server 30 that distributes the multimedia contents to the user viewing terminal 10, a viewing record managing server 40 that manages the viewing record of the multimedia contents at the user viewing terminal 10, and a network 20 that interconnects between the user viewing terminal 10, the contents server 30, and the viewing record managing server 40.

The user viewing terminal 10 is a computer terminal provided at the user side, and has a dedicated browser 11 to view multimedia contents. This dedicated browser 11 is different from a general browser in that the dedicated browser 11 has a viewing record managing section 12 provided from a vender of the viewing record managing server 40.

The viewing record managing section 12 manages the viewing record of the multimedia contents at the user viewing terminal 10, and has a function of uploading the viewing record management information to the viewing record managing server 40, a function of requesting the viewing record managing server 40 for the viewing record management information, a function of downloading the requested viewing record management information, and a function of reproducing the multimedia contents from the last viewing end position based on the viewing record management information.

The viewing end position means a time position at which the viewing of multimedia contents is ended in the middle on a play time axis of the multimedia contents. For example, assume that multimedia contents have a total play time of 60 minutes. When the viewing of the multimedia contents is ended at a time position elapsed by 25 minutes from a stating time of the play at zero minutes, the time position of 25 minutes becomes the viewing end position. When the multimedia contents are viewed again, the play is started at this viewing end position of 25 minutes.

The contents server 30 stores contents information 31 corresponding to the multimedia contents, and has a function of distributing the multimedia contents to the user viewing terminal 10 according to a distribution request made from the user viewing terminal 10.

The viewing record managing server 40 manages the viewing record of multimedia contents for each user. This viewing record managing server 40 has a viewing record management information database 41 that stores viewing record management information 42. The viewing record management information 42 is the information related to the viewing end position corresponding to the multimedia contents viewed at the user viewing terminal 10.

With the above structure, when a user carries out a predetermined operation, the user viewing terminal 10 issues a request for distributing multimedia contents via the network 20. The contents server 30 distributes the requested multimedia contents (i.e., the contents information 31) to the user viewing terminal 10.

Assume in this case that the distributed multimedia contents is viewed (but ended in the middle) last time at the user viewing terminal 10, and that the viewing record management information database 41 stores the viewing record management information 42 related to the viewing record indicating that the viewing is ended in the middle.

When the multimedia contents are distributed to the user viewing terminal 10, the viewing record managing section 12 makes a request for the viewing record management information corresponding to the multimedia contents, to the viewing record managing server 40.

Accordingly, the viewing record management information 42 is downloaded from the viewing record managing server 40 to the viewing record managing section 12. The viewing record managing section 12 instructs the dedicated browser 11 to play the multimedia contents from the viewing end position obtained from the viewing record management information 42.

The dedicated browser 11 plays the multimedia contents starting from the viewing end position, and the user views the played multimedia contents. As explained above, in the multimedia contents distributing system 50, when the user wants to view the same multimedia contents after a certain time interval, it is possible to start reproducing the multimedia contents from the last viewing end position based on the viewing record management information.

When the user has ended the viewing of the multimedia contents in the middle, the viewing record managing section 12 uploads the viewing end position at this point of time to the viewing record managing server 40 via the network 20 as the viewing record management information. With this arrangement, the viewing record managing server 40 stores the viewing record management information into the viewing record management information database 41.

A conventional example of the multimedia contents distributing system 50 that has the dedicated browser 11 included in the user viewing terminal 10 is explained above. There is also another conventional structure that a widely available browser is used in place of the dedicated browser 11 to thereby carry out a play of multimedia contents based on the viewing record. This structure will be explained below with reference to FIG. 14.

FIG. 14 is a block diagram of a conventional multimedia contents distributing system 80. In FIG. 14, sections corresponding to those in FIG. 13 are assigned with like reference numerals. In FIG. 14, a user viewing terminal 60 and a dedicated contents server 70 are provided in place of the user viewing terminal 10 and the contents server 30 shown in FIG. 13.

The user viewing terminal 60 is a computer terminal that is provided at a user side, and has a browser 61 for the user to view multimedia contents. This browser 61 is most widely available, and has a basic function of viewing contents.

This browser 61 has a script processor 62 that executes a script processing based on script information i.e., a computer program. This script processor 62 is included as standard equipment in the browser 61.

The dedicated contents server 70 stores dedicated contents information 71 corresponding to multimedia contents, and has a function of distributing the multimedia contents to the user viewing terminal 60 according to a distribution request made from the user viewing terminal 60.

In the multimedia contents distributing system 80, the dedicated contents information 71 is different from the contents information 31 shown in FIG. 13 in that the dedicated contents information 71 includes script information 72 processed by the script processor 62.

The script information 72 is the information for allowing the script processor 62 to execute a script processing i.e., viewing record management similar to the processing executed by the viewing record managing section 12 shown in FIG. 13.

Therefore, like the viewing record managing section 12 shown in FIG. 13, the script processor 62 implements the following functions based on the script information 72. That is, the script processor 62 implements the function of uploading the viewing record management information to the viewing record managing server 40, the function of requesting the viewing record managing server 40 for the viewing record management information, the function of downloading the requested viewing record management information, and the function of reproducing the multimedia contents from the last viewing end position based on the viewing record management information.

With the above structure, when a user carries out a predetermined operation, the user viewing terminal 60 issues a request for distribution of multimedia contents via the network 20. The dedicated contents server 70 distributes the requested multimedia contents (the dedicated contents information 71 and the script information 72) to the user viewing terminal 60.

Assume in this case that the distributed multimedia contents is viewed last time (but ended in the middle) at the user viewing terminal 60, and that the viewing record management information database 41 stores the viewing record management information 42 related to the viewing record indicating that the viewing is ended in the middle.

When the multimedia contents (the dedicated contents information 71 and the script information 72) are distributed to the user viewing terminal 60, the script processor 62 makes a request for the viewing record management information corresponding to the multimedia contents to the viewing record managing server 40 based on the script information 72.

Accordingly, the viewing record management information 42 is downloaded from the viewing record managing server 40 to the script processor 62. The script processor 62 instructs the browser 61 to play the multimedia contents from the viewing end position obtained from the viewing record management information 42, based on the script information 72.

The browser 61 plays the multimedia contents starting from the viewing end position, and the user views the played multimedia contents. As explained above, in the multimedia contents distributing system 80, when the user wants to view the same multimedia contents after a certain time interval, it is possible to start reproducing the multimedia contents from the last viewing end position based on the viewing record management information, in a similar manner to that in the multimedia contents distributing system 50 shown in FIG. 13.

When the user has ended the viewing of the multimedia contents in the middle, the script processor 62 uploads, as the viewing record management information, the viewing end position at this point of time to the viewing record managing server 40 via the network 20, based on the script information 72. With this arrangement, the viewing record managing server 40 stores the viewing record management information into the viewing record management information database 41.

As explained above, according to the conventional multimedia contents distributing system 50 shown in FIG. 13, the user can view multimedia contents based on the viewing record management information, by having the dedicated browser 11 included in the user viewing terminal 10 to communicate with the viewing record managing server 40.

However, in the multimedia contents distributing system 50, the dedicated browser 11 is solely used because it is a dedicated module. Therefore, there is a basic problem in that it is very difficult to achieve widespread use of the dedicated browser 11 like a general browser.

According to the multimedia contents distributing system 80 shown in FIG. 14, it is possible to manage the viewing record of multimedia contents based on the script information 72 included in the dedicated contents information 71, without using a dedicated browser.

However, the multimedia contents distributing system 80 has a problem in that it is impossible to manage the viewing record of general contents information such as the contents information 31 shown in FIG. 13 except for the dedicated contents information 71.

Further, the multimedia contents distributing system 80 requires preparation of the dedicated contents information 71 as particular contents. This becomes a bottleneck that makes it difficult to increase the dedicated contents.

As explained above, conventionally, the viewing record of multimedia contents can be managed only under the limited condition of using the dedicated browser or the dedicated contents. Therefore, there is a high barrier in achievement of widespread use of the multimedia contents.

### SUMMARY OF THE INVENTION

It is an object of this invention to solve at least the problems in the conventional technology.

According to one aspect of this invention, an apparatus services a viewing record of contents. The apparatus includes a distribution request receiving unit that receives a distribution request for contents from a user viewing terminal, and a viewing record inquiring unit that inquires an external viewing record managing device about a viewing record of the contents at the user viewing terminal, when the distribution request receiving unit has received the distribution request. The apparatus also includes a contents obtaining unit that obtains the contents from an external contents distributing device, a converting unit that converts the obtained contents into viewing-record reflected contents that reflect the viewing record, and a distributing unit that distributes the viewing-record reflected contents to the user viewing terminal.

According to another aspect of this invention, a method of servicing a viewing record of contents includes the steps of receiving a distribution request for contents from a user viewing terminal, and inquiring an external viewing record managing device about a viewing record of the contents at the user viewing terminal, when the distribution request has been received. The method also includes the steps of obtaining the contents from an external contents distributing device, converting the contents obtained into viewing-record reflected contents that reflect the viewing record, and distributing the viewing-record reflected contents to the user viewing terminal.

According to still another aspect of this invention, a computer program makes it possible to execute the method according to the present invention on a computer.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of a multimedia contents distributing system according to one embodiment of the present invention;

FIG. 2 shows a table structure of a banner advertisement information database shown in FIG. 1;

FIG. 3 shows a table structure of a contents genre information database shown in FIG. 1;

FIG. 4 shows a table structure of a viewing record management information database shown in FIG. 1;

FIG. 5 shows pre-conversion contents according to the embodiment;

FIG. 6 shows post-conversion contents according to the embodiment;

FIG. 7 is a sequence diagram of the operation of the multimedia contents distributing system according to the embodiment;

FIG. 8 shows URL-1 to URL-4 according to the embodiment;

FIG. 9 shows URL-5 to URL-8 according to the embodiment;

FIG. 10 is a flowchart of a post-conversion contents processing according to the embodiment;

FIG. 11 is a flowchart of a button operation processing shown in FIG. 10;

FIG. 12 is a block diagram of a modification of the embodiment;

FIG. 13 is a block diagram of the conventional multimedia contents distributing system; and

FIG. 14 is a block diagram of the conventional multimedia contents distributing system.

### DETAILED DESCRIPTION

Exemplary embodiments of the method, the apparatus, and the computer program according to the present invention will be explained in detail below with reference to the accompanying drawings.

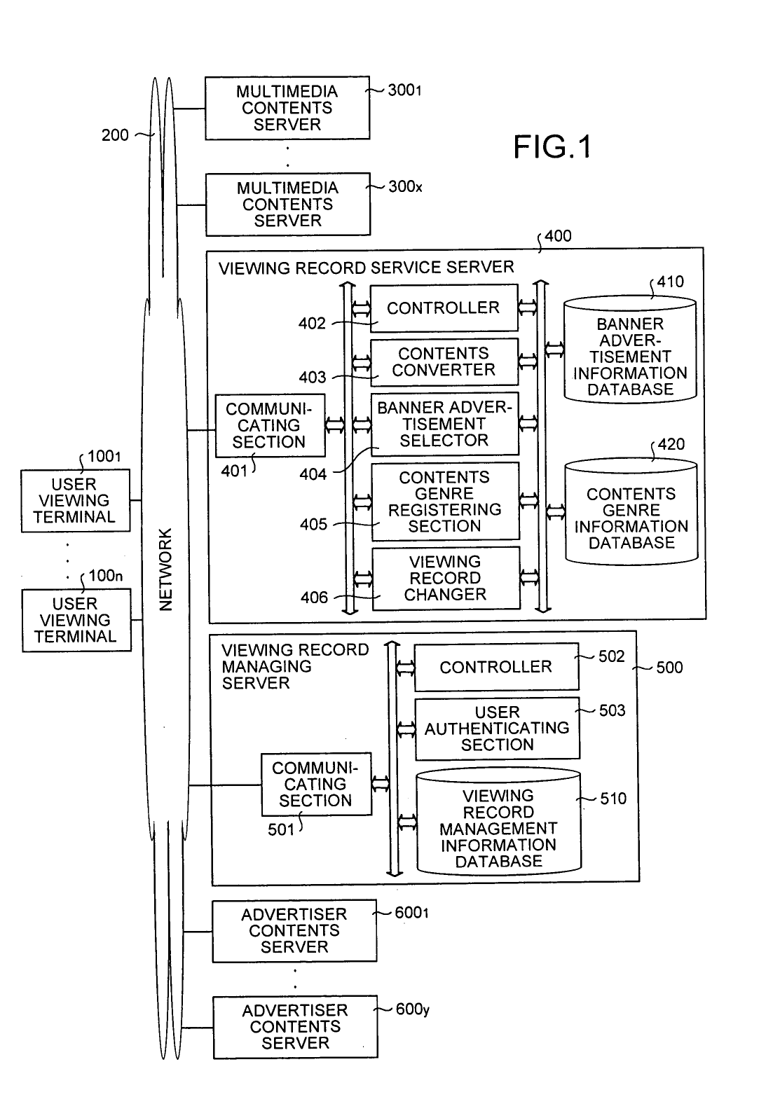

FIG. 1 is a block diagram of a multimedia contents distributing system according to one embodiment of the present invention. FIG. 1 shows the multimedia contents distributing system that has a function of distributing multimedia contents that display motion pictures, audios, texts, and still pictures in combination, and a function of managing the viewing record of the multimedia contents.

The multimedia contents distributing system includes user viewing terminals 100₁ to 100ₙ, multimedia contents servers 300₁ to 300ₓ, a viewing record service server 400, a viewing record managing server 500, advertiser contents servers 600₁ to 600_{y}, and a network 200 that interconnects these constituent elements.

Each of the user viewing terminals 100₁ to 100ₙ is a computer terminal provided at a user side, for the user to view multimedia contents at the terminal. Each of these user viewing terminals has a browser that is widely available.

Each of the multimedia contents servers 300₁ to 300ₓ stores multimedia contents such as a video image. Each multimedia contents server distributes multimedia contents to the user viewing terminals 100₁ to 100ₙ by downloading or streaming according to contents distribution requests made from these user viewing terminals.

The multimedia contents are not directly distributed from the multimedia contents servers 300₁ to 300ₓ to the user viewing terminals 100₁ to 100ₙ. The multimedia contents are distributed indirectly to the user viewing terminals 100₁ to 100ₙ via the viewing record service server 400, in a state in which the viewing record managing function is added to the multimedia contents.

The viewing record service server 400 has a function of receiving a distribution request for multimedia contents from any one of the user viewing terminals 100₁ to 100ₙ, a function of inquiring for the viewing record management information corresponding to the multimedia contents from the viewing record managing server 500, and a function of registering a genre of the multimedia contents.

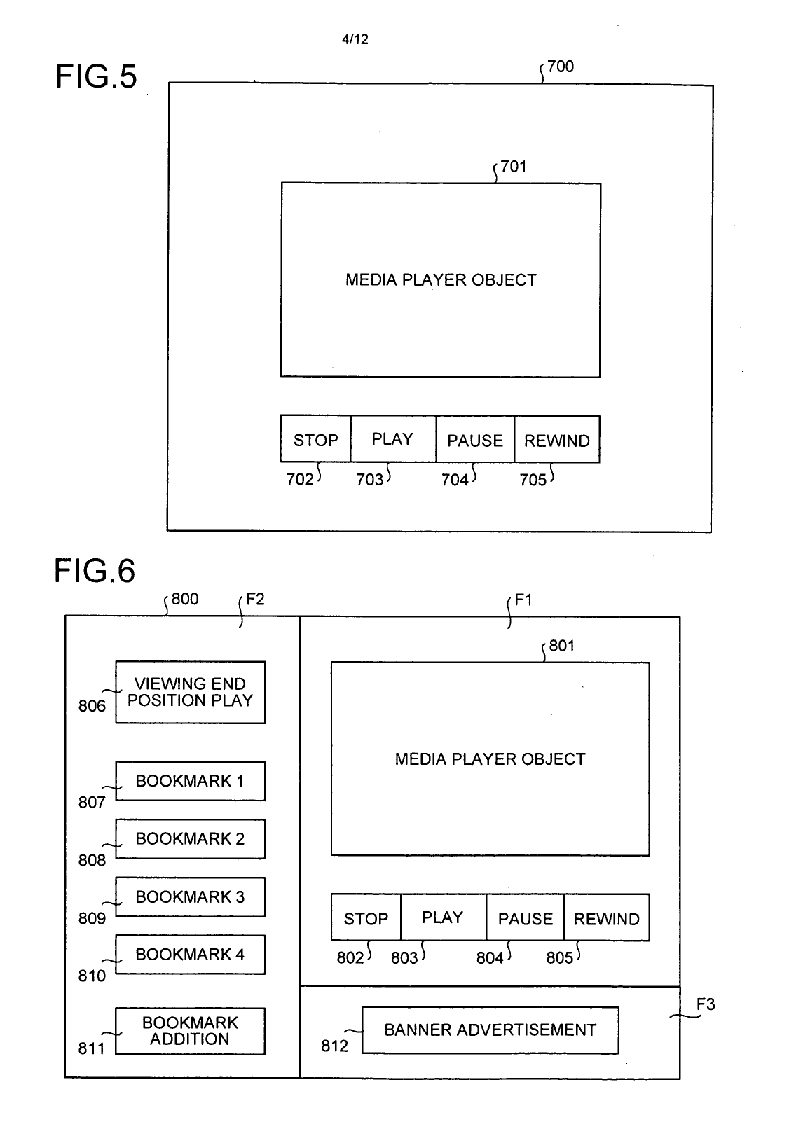

The viewing record service server 400 further has a function of obtaining multimedia contents (pre-conversion contents 700: see FIG. 5) from the multimedia contents servers 300₁ to 300ₓ, a function of converting the obtained multimedia contents into multimedia contents (post-conversion contents 800: see FIG. 6) that reflect a viewing record and a banner advertisement respectively, and a function of distributing the post-conversion multimedia contents to corresponding user viewing terminals.

In the viewing record service server 400, a communicating section 401 controls communications between the user viewing terminals 100₁ to 100ₙ, the multimedia contents servers 300₁ to 300ₓ, and the viewing record managing server 500, according to a predetermined communication protocol.

A controller 402 controls various sections. A contents converter 403 has a function of receiving a distribution request for multimedia contents from any one of the user viewing terminals 100₁ to 100ₙ, and obtaining the viewing record management information related to the multimedia contents from the viewing record managing server 500.

The contents converter 403 also has a function of obtaining the pre-conversion contents (multimedia contents) corresponding to the distribution request, from any one of the multimedia contents servers 300₁ to 300ₓ.

The contents converter 403 also has a function of converting the obtained pre-conversion contents (such as the pre-conversion contents 700: see FIG. 5) into the post-conversion contents (such as the post-conversion contents 800: see FIG. 6) that reflect the viewing record management information and the banner advertisement to be described later, and distributing the post-conversion contents to the corresponding user viewing terminal.

A banner advertisement selector 404 has a function of selecting a banner advertisement to be contained in the post-conversion contents, from among a plurality of banner advertisements corresponding to pieces of banner advertisement information stored in a banner advertisement information database 410. This banner advertisement is an image (such as a banner advertisement 812: see FIG. 6) having predetermined sizes (such as 468 lateral pixels×60 vertical pixels) that includes image information and text information to gain an advertising effect.

This banner advertisement is correlated with a uniform resource locator (URL) to specify a site position of an advertiser of a link destination (commercial site provided by one of the advertiser contents servers 600₁ to 600_{y}).

As explained above, the banner advertisement is contained in the post-conversion contents (multimedia contents) to be viewed by the user, and the contained banner advertisement is used for inviting the user to the site of the advertiser at a link destination (a traffic guide destination) when the user clicks the banner advertisement.

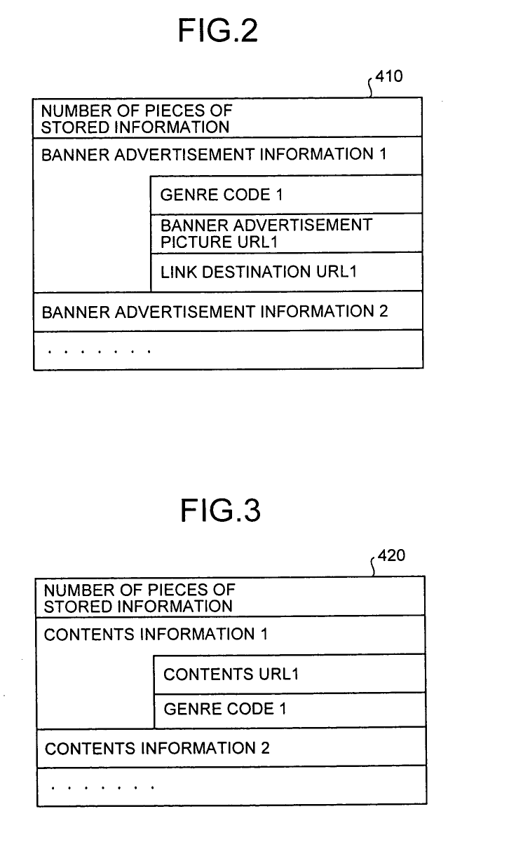

The banner advertisement information database 410 stores the banner advertisement information related to the banner advertisement. Specifically, as shown in FIG. 2, the banner advertisement information database 410 has fields of “number of pieces of stored information”, “banner advertisement information 1”, “banner advertisement information 2”, and so on.

The “number of pieces of stored information” indicates the number of pieces of banner advertisement information stored in the banner advertisement information database 410. The “banner advertisement information 1” has fields of “genre code 1”, “banner advertisement image URL1”, and “link destination URL1” related to the banner advertisement.

The “genre code 1” represents a genre corresponding to a user's preference, and is correlated with the banner advertisement. For example, if the “genre code 1” is a code corresponding to sports, then the corresponding banner advertisement is linked to advertiser sites related to sports.

The “banner advertisement image URL1” represents a storage location of the image information for the banner advertisement. The “link destination URL1” represents a site of the advertiser as the link destination of the banner advertisement. Each of the “banner advertisement information 2” and so on also has fields similar to those of the “banner advertisement information 1”.

Referring back to FIG. 1, a contents genre registering section 405 is started when a genre code of contents to be viewed is not known (=0). The contents genre registering section 405 has a function of determining a genre code corresponding to the contents based on a contents genre information database 420 shown in FIG. 3. The contents genre registering section 405 also has a function of registering the determined genre code into the viewing record managing server 500.

The contents genre information database 420 stores contents genre information related to contents (multimedia contents), and the genre code corresponding to the contents.

Specifically, as shown in FIG. 3, the contents genre information database 420 has fields of “number of pieces of stored information”, “contents information 1”, “contents information 2”, and so on.

The “number of pieces of stored information” represents a number of pieces of contents genre information stored in the contents genre information database 420. The “contents information 1” has fields of “contents URL1” and “genre code 1” related to the contents.

The “contents URL1” represents a storage location of the contents (the multimedia contents), that is, a storage location in any one of the multimedia contents servers 300₁ to 300ₓ. The “genre code 1” represents a genre of the contents. Each of the “contents information 2” and so on also has fields similar to those of the “contents information 1”.

Referring back to FIG. 1, a viewing record changer 406 has a function of changing the viewing record management information in the viewing record managing server 500, when the user viewing terminal has requested the viewing record changer 406 to change the viewing record based on the addition of a bookmark to be described later while the user is viewing the post-conversion contents 800 shown in FIG. 6.

The viewing record managing server 500 has a function of managing a viewing record of multimedia contents (such as the post-conversion contents 800: see FIG. 6) at any one of the user viewing terminals 100₁ to 100ₙ, and a function of authenticating a user.

In the viewing record managing server 500, a communicating section 501 controls communications with the viewing record service server 400 according to a predetermined communication protocol. A controller 502 controls storage of viewing record information into a viewing record management information database 510 and updating of the viewing record management information according to a request from the viewing record service server 400.

The viewing record management information database 510 stores for each user the viewing record management information related to the viewing record of multimedia contents that are distributed from the multimedia contents servers 300₁ to 300ₓ and are viewed at any one of the user viewing terminals 100₁ to 100ₙ.

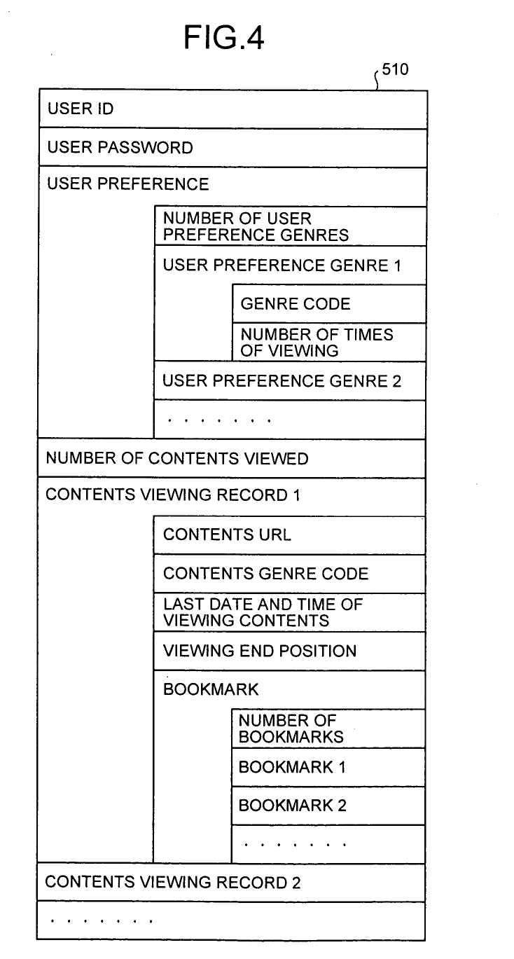

Specifically, as shown in FIG. 4, the viewing record management information database 510 has fields of “user ID”, “user password”, “user preference”, “number of contents viewed”, “contents viewing record 1”, “contents viewing record 2”, and so on.

The “user ID” is an identifier that identifies a user. The “user password” is a password allocated to the user, and is used together with the “user ID” to authenticate the user.

The “user preference” is information related to the preference of the user, and has fields of “number of user preference genres”, “user preference genre 1”, “user preference genre 2”, and so on. The “number of user preference genres” represents a number of genres corresponding to the user preference.

The “user preference genre 1” corresponds to “genre code” and “number of times of viewing”. The “genre code” represents a genre. The “number of times of viewing” represents a number of times when the user has viewed the multimedia contents in correlation with the genre code (see FIG. 3) that is the same as the above “genre code”. The “user preference genre 2” also has fields similar to those of the “user preference genre 1”.

The “number of contents viewed” represents a number of multimedia contents that the user has viewed at the user viewing terminal. Each of the “contents viewing record 1”, “contents viewing record 2”, and so on corresponds to the viewing record management information of each multimedia contents.

The “contents viewing record 1” has fields of “contents URL”, “contents genre code”, “last date and time of viewing”, “viewing end position”, and “bookmark”.

The “contents URL” corresponds to the “contents URL1” and the like shown in FIG. 3, and represents a storage location of the contents (the multimedia contents) in any one of the multimedia contents servers 300₁ to 300ₓ. The “contents genre code” corresponds to the “genre code 1” and the like shown in FIG. 3, and represents a genre of the contents.

The “last date and time of viewing” represents the last or the latest date and time when the user has viewed the contents. The “viewing end position” represents a time position where the user has ended the viewing of the multimedia contents or has ended in the middle on the play time axis. Therefore, When multimedia contents have a total play time of 60 minutes and the user has ended the viewing of the contents at a time position elapsed by 25 minutes from starting the play at zero minutes, the time position of 25 minutes becomes the viewing end position.

The “bookmark” represents a time position on the play time axis when the user marks a certain scene during the viewing of the multimedia contents. The “bookmark” has fields of “number of bookmarks”, “bookmark 1”, “bookmark 2”, and so on. The “number of bookmarks” represents a number of bookmarks.

The “bookmark 1” represents a first bookmark at a position on the play time axis. The “bookmark 2” represents a second bookmark at a position on the play time axis.

These “bookmark 1”, “bookmark 2”, and so on correspond to bookmark buttons 807, 808, and so on of the post-conversion contents 800 (see FIG. 6) to be described later. As explained above, according to the embodiment, it is possible to set a plurality of bookmarks for one piece of multimedia contents. Each of the “contents viewing record 2” and so on also has fields similar to those of the “contents viewing record 1”.

Referring back to FIG. 1, a user authenticating section 503 checks a user ID and a user password notified from a user viewing terminal against those in the viewing record management information database 510 and performs user authentication, when the user viewing terminal makes a distribution request for multimedia contents.

Each of the advertiser contents servers 600₁ to 600_{y} provides an advertisement site as a link destination of the banner advertisement (such as the banner advertisement 812: see FIG. 6).

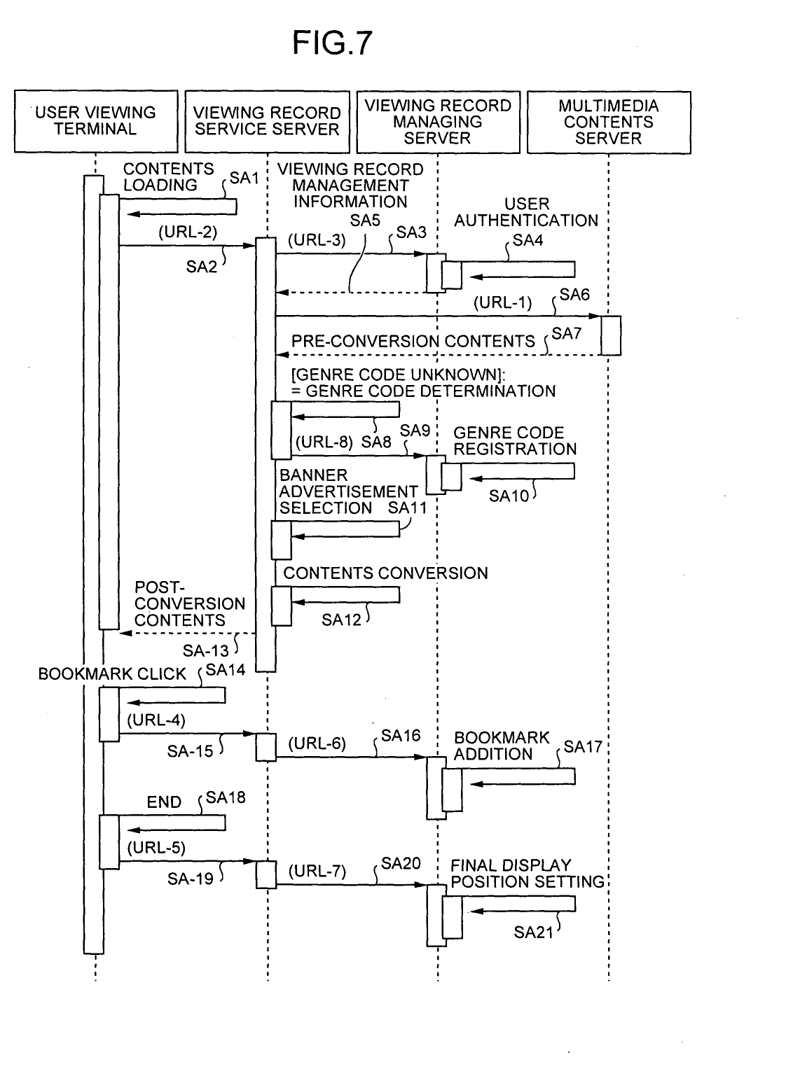

The operation of the multimedia contents distributing system according to the embodiment will be explained below with reference to FIG. 7 to FIG. 11. FIG. 7 is a sequence diagram of the operation of the multimedia contents distributing system according to the embodiment. The following case will be explained below. That is, the case is such that the user viewing terminal 100₁ shown in FIG. 1 issues a distribution request for multimedia contents to the viewing record service server 400, the viewing record service server 400 distributes the multimedia contents sent from the multimedia contents server 300₁, and the viewing record managing server 500 manages the viewing record of the multimedia contents.

It is assumed that the multimedia contents to be distributed is viewed last time by the user at the user viewing terminal 100₁ but the viewing the last time is ended in the middle, and that the viewing record management information database 510 stores the viewing record management information related to the viewing record of this viewing that is ended in the middle.

At step SA1 in FIG. 7, the user instructs the user viewing terminal 100₁ to load multimedia contents for the user to view the contents.

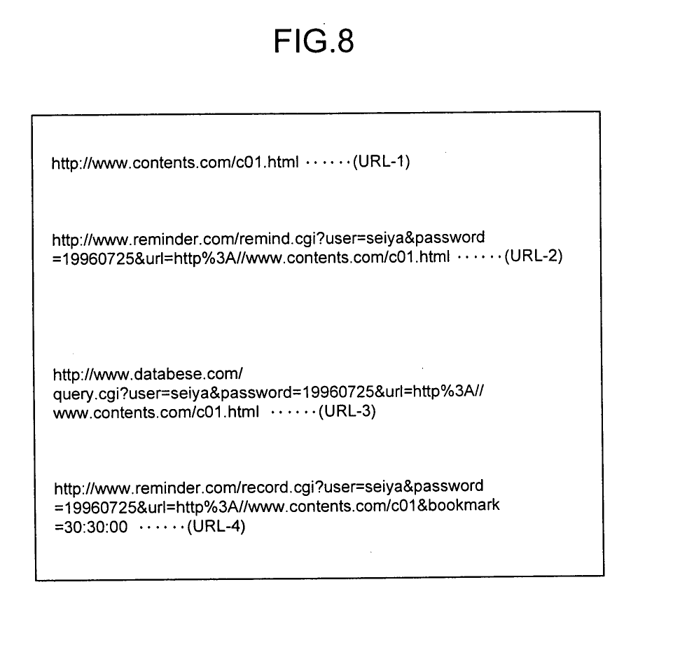

At step SA2, the user viewing terminal 100₁ notifies the viewing record service server 400 of a URL-2 shown in FIG. 8 via the network 200. In this URL-2, “http://www.reminder.com” is a URL of the viewing record service server 400.

In the URL-2, “seiya” is a user ID allocated to the user, “19960725” is a user password, and “http%3A(:)//www.contents.com/c01.html” is a URL (a storage location in the multimedia contents server 300₁) of the multimedia contents that the user wants to view.

When the URL-2 is notified to the viewing record service server 400, at step SA3, the contents converter 403 generates a URL-3 shown in FIG. 8 based on the URL-2, and notifies the viewing record managing server 500 of this URL-3.

This URL-3 is information for obtaining the viewing record management information from the viewing record managing server 500. In this URL-3, “http://www.databese.com” is a URL of the viewing record managing server 500.

When the URL-3 is notified to the viewing record managing server 500, at step SA4, the user authenticating section 503 of the viewing record managing server 500 extracts the “seiya” and “19960725” (the user ID and the user password) from the URL-3. The viewing record managing server 500 checks the user ID and the user password against the user ID and the user password in the viewing record management information database 510 shown in FIG. 4 to perform user authentication. When the result of checking does not indicate coincidence with each other, the user authenticating section 503 sends back an error notice and ends the processing.

When the result of checking indicates coincidence with each other, at step SA5, the controller 502 obtains the information of the contents viewing record 1 and the information of the user preference from the viewing record management information database 510, by using as a key the “http%3A(:)//www.contents.com/c01.html” (the contents URL) included in the URL-3 shown in FIG. 8. The controller 502 transmits the obtained information of the contents viewing record 1 and user preference to the viewing record service server 400 as the viewing record management information.

When the viewing record service server 400 has obtained the viewing record management information, at step SA6, the contents converter 403 extracts the “http%3A(:)//www.contents.com/c01.html” (the contents URL) from the URL-2 shown in FIG. 8. The contents converter 403 accesses the multimedia contents server 300₁ by using the extracted contents URL as the URL-1 (see FIG. 8), and requests the multimedia contents server 300₁ to distribute the pre-conversion contents 700 shown in FIG. 5.

In the pre-conversion contents 700, a media player object 701 is a video image or the like to be viewed. A stop button 702 is used to stop the viewing of the media player object 701. A play button 703 is used to play the media player object 701 to view the contents.

A pause button 704 is used to pause the play or the viewing. A rewind button 705 is used to play and view the media player object 701 after rewinding the media player object 701.

When receiving a request for distributing the pre-conversion contents 700, at step SA7, the multimedia contents server 300₁ distributes the pre-conversion contents 700 shown in FIG. 5 to the viewing record service server 400.

When the viewing record service server 400 obtains at step SA5 the viewing record management information that includes the contents gender code 0 (i.e., genre unknown), at step SA8, the contents genre registering section 405 determines, as a genre code of the unknown genre contents, the genre code corresponding to any of user preferences, viewed the largest number of times, included in the viewing record management information.

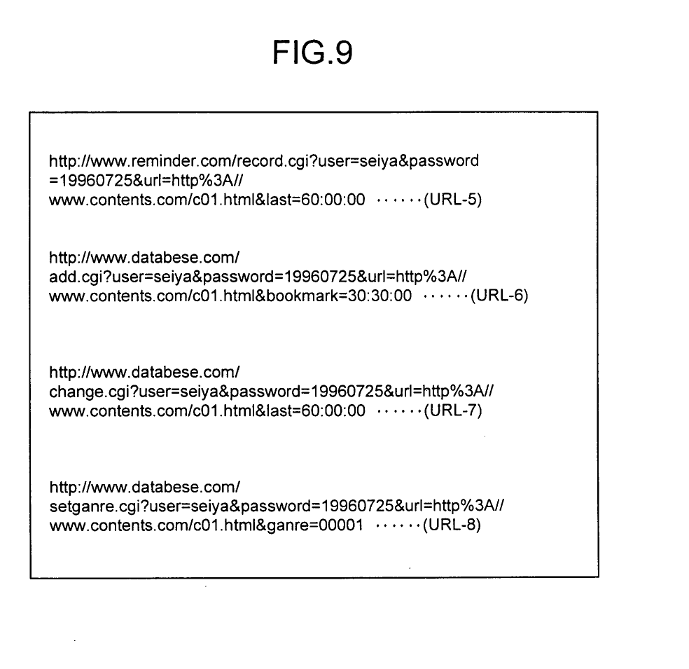

At step SA9, the contents genre registering section 405 generates a URL-8 shown in FIG. 9 in order to register the determined genre code into the viewing record management information database 510, and notifies the viewing record managing server 500 of the generated URL-8. In this URL-8, “http://www.databese.com” is a URL of the viewing record managing server 500.

In the URL-8, “seiya” and “19960725” (i.e., the user ID and the user password) are those extracted from the URL-2. “http%3A(:)://www.contents.com/c01.html&ganre” shows the contents URL and the contents genre code (see FIG. 4). Code “00001” is a genre code determined at step SA8.

When the URL-8 has been notified to the viewing record managing server 500, at step SA10, the user authenticating section 503 authenticates the user, and the controller 502 registers the genre code “00001” included in the URL-8 into the “contents genre code” in the viewing record management information database 510.

When the viewing record service server 400 obtains at step SA5 the viewing record management information including the contents gender code that is other than 0, the processing at step SA8 to step SA10 is skipped.

At step SA11, the banner advertisement selector 404 selects a banner advertisement to be contained in the post-conversion contents 800 (see FIG. 6). Specifically, the banner advertisement selector 404 extracts a genre code from the contents genre information database 420 shown in FIG. 3, by using as a key the contents URL “http%3A(:)//www.contents.com/c01.html” included in the URL-2 (see FIG. 8).

Next, the banner advertisement selector 404 extracts the banner advertisement information from the banner advertisement information database 410 shown in FIG. 2 by using the extracted genre code as a key, and selects the banner advertisement corresponding to this banner advertisement information as the banner advertisement to be contained. In other words, the banner advertisement selector 404 selects the banner advertisement that belongs to the same genre as the genre of the multimedia contents viewed at the user viewing terminal 100₁.

In the embodiment, in place of the genre code of the above multimedia contents, the banner advertisement selector 404 may select the banner advertisement of the genre code corresponding to the user preference genre, viewed the largest number of times, included in the viewing record management information obtained by the viewing record service server 400 at step SA5.

Further, in the embodiment, in place of the genre code of the above multimedia contents, the banner advertisement selector 404 may select a banner advertisement of the genre code corresponding to the multimedia contents that is viewed the largest number of times at the user viewing terminal 100₁.

At step SA12, the contents converter 403 converts the pre-conversion contents 700 (see FIG. 5) obtained at step SA7 to the post-conversion contents 800 (see FIG. 6) that reflect the viewing record management information obtained at step SA5.

The screen of the post-conversion contents 800 is divided into three frames of F1, F2, and F3. The frame F1 corresponds to the pre-conversion contents 700 shown in FIG. 5. In other words, in the frame F1, a media player object 801 corresponds to the media player object 701 shown in FIG. 5 as a video image or the like to be viewed.

A stop button 802, a play button 803, a pause button 804, and a rewind button 805 correspond to the stop button 702, the play button 703, the pause button 704, and the rewind button 705 shown in FIG. 5, respectively.

In other words, the stop button 802 is used to stop the viewing of the media player object 801. The play button 803 is used to play the media player object 801 to view the contents.

The pause button 804 is used to pause the play or the viewing. The rewind button 805 is used to play and view the media player object 801 after rewinding the media player object 801.

The frame F2 relates to the viewing record of the multimedia contents. In this frame F2, a viewing end position play button 806 is related to the viewing end position of the viewing record management information (see FIG. 4) obtained at step SA5. Further, the viewing end position play button 806 is used to play the media player object 801 (i.e., the multimedia contents) starting from the last viewing end position.

The bookmark buttons 807 to 810 are related to the “bookmark 1”, “bookmark 2”, and so on in the viewing record management information obtained at step SA5.

These bookmark buttons 807, 808, and so on are used to play the media player object 801 (i.e., the multimedia contents) from a time position on the bookmarked play time axis.

A bookmark addition button 811 is used to add a position on the play time axis as a bookmark while the user is viewing the media player object 801 (i.e., the multimedia contents). The frame F3 displays the banner advertisement 812 selected at step SA11.

At step SA13, the contents converter 403 distributes the post-conversion contents 800 (see FIG. 6) to the user viewing terminal 100₁ as an originator of the request, via the network 200.

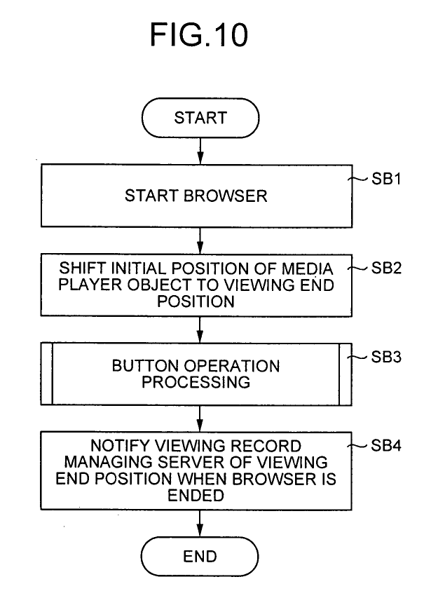

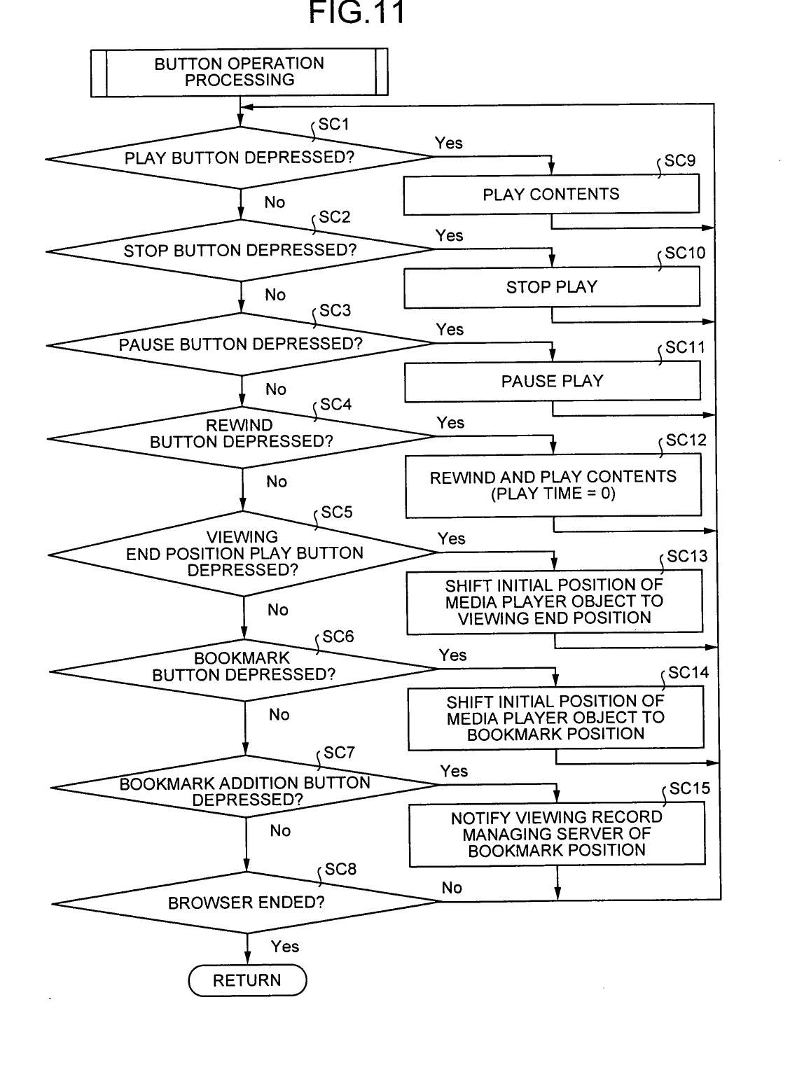

At the user viewing terminal 100₁, the user can view the post-conversion contents 800 shown in FIG. 6. In other words, at step SB1 shown in FIG. 10, the browser (not shown) is started for the user to view the post-conversion contents 800 at the user viewing terminal 100₁.

At step SB2, the user viewing terminal 100₁ shifts the initial position of the media player object 801 to the viewing end position. At step SB3, the user depresses the button. Specifically, at step SC1 shown in FIG. 11, the user viewing terminal 100₁ decides whether the play button 803 has been depressed, and sets “No” as a result of the decision made in this case.

At step SC2, the user viewing terminal 100₁ decides whether the stop button 802 has been depressed, and sets “No” as a result of the decision made in this case. At step SC3, the user viewing terminal 100₁ decides whether the pause button 804 is depressed, and sets “No” as a result of the decision made in this case.

At step SC4, the user viewing terminal 100₁ decides whether the rewind button 805 has been depressed, and sets “No” as a result of the decision made. At step SC5, the user viewing terminal 100₁ decides whether the viewing end position play button 806 has been depressed, and sets “No” as a result of the decision made in this case.

At step SC6, the user viewing terminal 100₁ decides whether any one of the bookmark buttons 807 to 810 has been depressed, and sets “No” as a result of the decision made in this case. At step SC7, the user viewing terminal 100₁ decides whether the bookmark addition button 811 has been depressed, and sets “No” as a result of the decision made in this case.

At step SC8, the user viewing terminal 100₁ decides whether the browser has been ended, and sets “No” as a result of the decision made in this case. Thereafter, the user viewing terminal 100₁ repeats making the decisions at steps SC1 to SC8.

When the user has depressed the play button 803, the user viewing terminal 100₁ sets “Yes” as a result of the decision made at step SC1. At step SC9, the user viewing terminal 100₁ plays the media player object 801 (contents) starting from the last viewing end position.

When the user has depressed the bookmark addition button 811 at a certain scene while viewing the contents, the user viewing terminal 100₁ sets “Yes” as a result of the decision made at step SC7. At step SC15, the user viewing terminal 100₁ notifies the viewing record managing server 500 of the bookmark position at the bookmarked time.

Specifically, when the bookmark addition button 811 has been depressed at step SA14 shown in FIG. 7, at step SA15, the user viewing terminal 1001 notifies the viewing record service server 400 of a URL-4 shown in FIG. 8. This URL-4 is the information for notifying the viewing record managing server 500 of the bookmark position via the viewing record service server 400. In this URL-4, “http://www.reminder.com” is a URL of the viewing record service server 400.

In the URL-4, “seiya” and “19960725” represent a user ID and a user password allocated to the user respectively, “http%3A(:)//www.contents.com/c01.html” is a URL (a storage location in the multimedia contents server 300₁) of the multimedia contents to be bookmarked, and “30:30:00” represents a bookmark position on the play time axis when the user has depressed the bookmark addition button 811.

When the URL-4 has been notified to the viewing record service server 400, at step SA16, the viewing record changer 406 generates a URL-6 shown in FIG. 9 based on the URL-4 shown in FIG. 8, and notifies the viewing record managing server 500 of this URL-6. This URL-6 is information for registering the information of the bookmark position into the viewing record managing server 500. In this URL-6, “http://www.databese.com” is a URL of the viewing record managing server 500.

In the URL-6, “seiya” and “19960725” (the user ID and the user password) are those extracted from the URL-4 shown in FIG. 8, “http%3A(:)//www.contents.com/c01.html” is the contents URL, and “30:30:00” represents a bookmark position.

When the URL-6 has been notified to the viewing record managing server 500, at step SA17, the user authenticating section 503 authenticates the user, and the controller 502 registers the “30:30:00” (i.e., the bookmark position) included in the URL-6 into, for example, the “bookmark 5 (not shown)” of the contents URL in the viewing record management information database 510.

When the stop button 802 shown in FIG. 6 has been depressed, the user viewing terminal 100₁ sets “Yes” as a result of the decision made at step SC2 shown in FIG. 11. At step SC10, the user viewing terminal 100₁ stops the play of the media player object 801.

When the pause button 804 has been depressed, the user viewing terminal 100₁ sets “Yes” as a result of the decision made at step SC3 shown in FIG. 11. At step SC11, the user viewing terminal 100₁ suspends the play of the media player object 801.

When the rewind button 805 has been depressed, the user viewing terminal 100₁ sets “Yes” as a result of the decision made at step SC4 shown in FIG. 11. At step SC12, the user viewing terminal 100₁ rewinds and then plays the media player object 801.

When the viewing end position play button 806 has been depressed, the user viewing terminal 100₁ sets “Yes” as a result of the decision made at step SC5 shown in FIG. 11. At step SC13, the user viewing terminal 100₁ shifts the initial position of the media player object 801 to the viewing end position, and plays this media player object 801.

For example, when the bookmark button 807 has been depressed, the user viewing terminal 100₁ sets “Yes” as a result of the decision made at step SC6 shown in FIG. 11. At step SC14, the user viewing terminal 100₁ shifts the initial position of the media player object 801 to the bookmark position corresponding to the bookmark button 807 depressed position, and plays this media player object 801. When the banner advertisement 812 shown in FIG. 6 has been depressed, the site of the advertiser provided from the advertiser contents server 600₁ at the link destination is displayed at the user viewing terminal 100₁.

When the user ends the browser on the user viewing terminal 100₁ to end the viewing, the user viewing terminal 100₁ sets “Yes” as a result of the decision made at step SC8. At step SB4 shown in FIG. 10, the user viewing terminal 100₁ notifies the viewing record managing server 500 of the viewing end position when the browser is ended.

Specifically, when the user ends the browser on the user viewing terminal 100₁ at step SA18 shown in FIG. 7, at step SA19, the user viewing terminal 100₁ notifies the viewing record service server 400 of a URL-5 shown in FIG. 9.

This URL-5 is information for notifying the viewing record managing server 500 of the viewing end position of the media player object 801 when the browser is ended, via the viewing record service server 400.

In this URL-5, “http://www.reminder.com” is a URL of the viewing record service server 400, “seiya” and “19960725” represent a user ID and a user password allocated to the user respectively, and “http%3A(:)//www.contents.com/c01.html” is a URL (a storage location in the multimedia contents server 300₁) of the multimedia contents. Further, in this URL-5, “60:00:00” represents a viewing end position on the play time axis when the user has ended the browser.

When the URL-5 has been notified to the viewing record service server 400, at step SA20, the viewing record changer 406 generates a URL-7 based on the URL-5, and notifies the viewing record managing server 500 of this URL-7. This URL-7 is information for registering the information of the viewing end position into the viewing record managing server 500. In this URL-7, “http://www.databese.com” is a URL of the viewing record managing server 500.

In the URL-7, “seiya” and “19960725” (the user ID and the user password) are those extracted from the URL-5, “http%3A(:)//www.contents.com/c01.html” is the contents URL, and “60:00:00” represents the viewing end position.

When the URL-7 has been notified to the viewing record managing server 500, at step SA21, the user authenticating section 503 authenticates the user, and the controller 502 registers the “60:00:00” (the viewing end position) included in the URL-7 into, for example, the “viewing end position” of the contents URL in the viewing record management information database 510.

When the multimedia contents is viewed next time at the user viewing terminal 100₁, the multimedia contents are played starting from the viewing end position registered at step SA21 through the above operation.

As explained above, when a contents distribution request has been received from any one of the user viewing terminals 100₁ to 100ₙ, the viewing record of the contents at this user viewing terminal is inquired to the external viewing record managing server 500. The post-conversion contents 800 (see FIG. 6) that is obtained through conversion of the pre-conversion contents 700 (see FIG. 5) obtained from the multimedia contents server 300₁ and that reflects the viewing record, are distributed to this user viewing terminal. Therefore, it is possible to carry out the online management of add-on viewing records to the general-purpose contents, without using a dedicated browser or dedicated contents.

Further, the pre-conversion contents 700 are converted into the post-conversion contents 800 so that the user can view the contents starting from the viewing end position. Therefore, the viewing the contents can be started from the last viewing end position at the user viewing terminal without using a dedicated browser or dedicated contents.

Further, the pre-conversion contents 700 are converted into the post-conversion contents 800 having the function of allowing the viewing of the contents to be started from the bookmark position. Therefore, the viewing the contents can be started from the bookmark position at the user viewing terminal without using a dedicated browser or dedicated contents.

Further, the pre-conversion contents 700 are converted into the post-conversion contents 800 having the function of registering into the viewing record managing server 500 the viewing end position at which the user ends viewing the post-conversion contents 800. Therefore, it is possible to make the viewing record managing server 500 carry out the online management of the viewing record (the viewing end position) of the contents without using a dedicated browser or dedicated contents.

Further, the pre-conversion contents 700 are converted into the post-conversion contents 800 that include the banner advertisement 812 (see FIG. 6) having a high relevance to either the contents or the user. Therefore, it is possible to utilize this system as the advertisement distributing system that realizes one-to-one marketing.

Further, the pre-conversion contents 700 are converted into the post-conversion contents 800 having the function of adding a bookmark position to the post-conversion contents 800 while the user is viewing the contents 800, and the function of registering the bookmark position into the viewing record managing server 500 as the viewing record. Therefore, it is possible to make the viewing record managing server 500 (which is different from the viewing record service server 400) carry out the online management of the viewing record (bookmark position) of the contents without using a dedicated browser or dedicated contents.

While the system according to one embodiment of the present invention has been explained in detail with reference to the drawings above, detailed structure examples are not limited to this embodiment. Any design modification within a scope not departing from the gist of the present invention is included in the present invention.

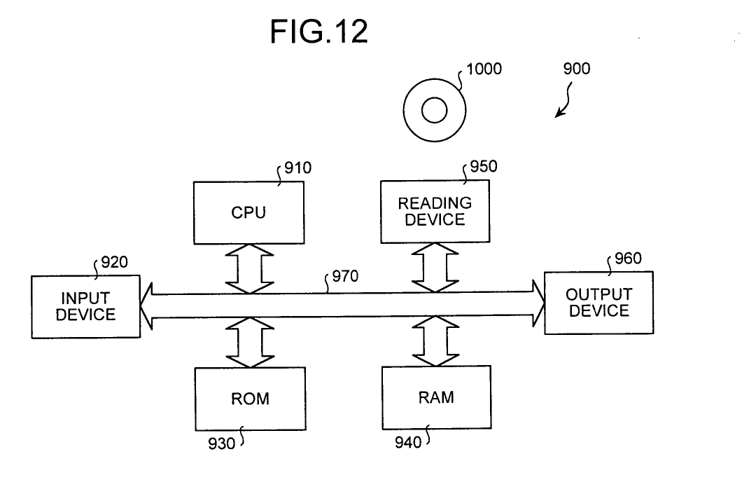

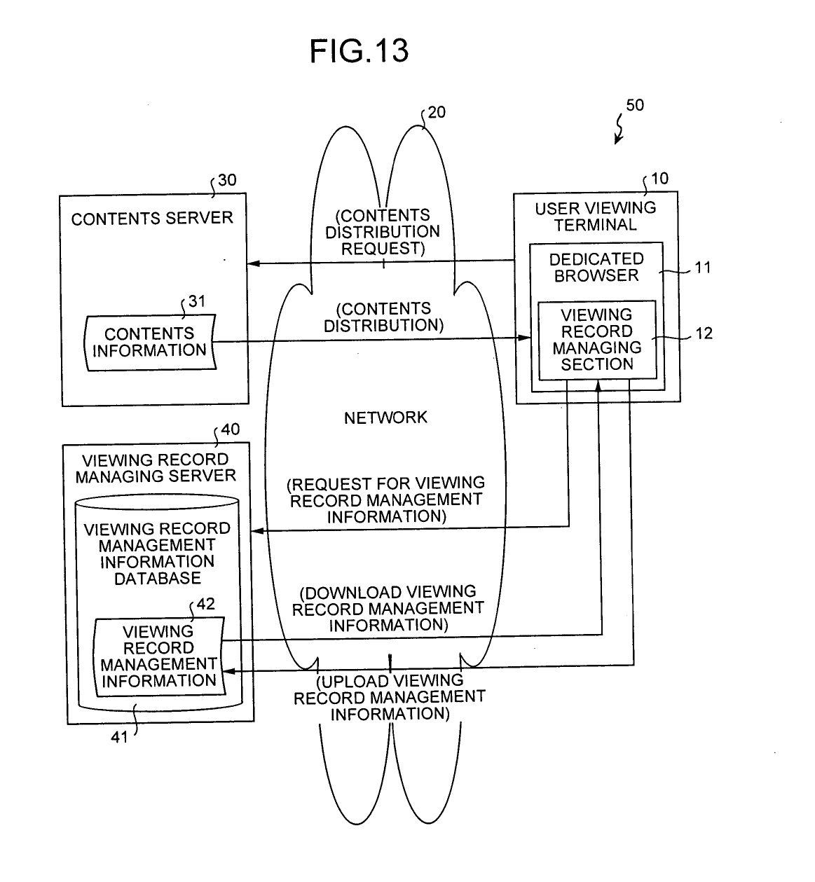

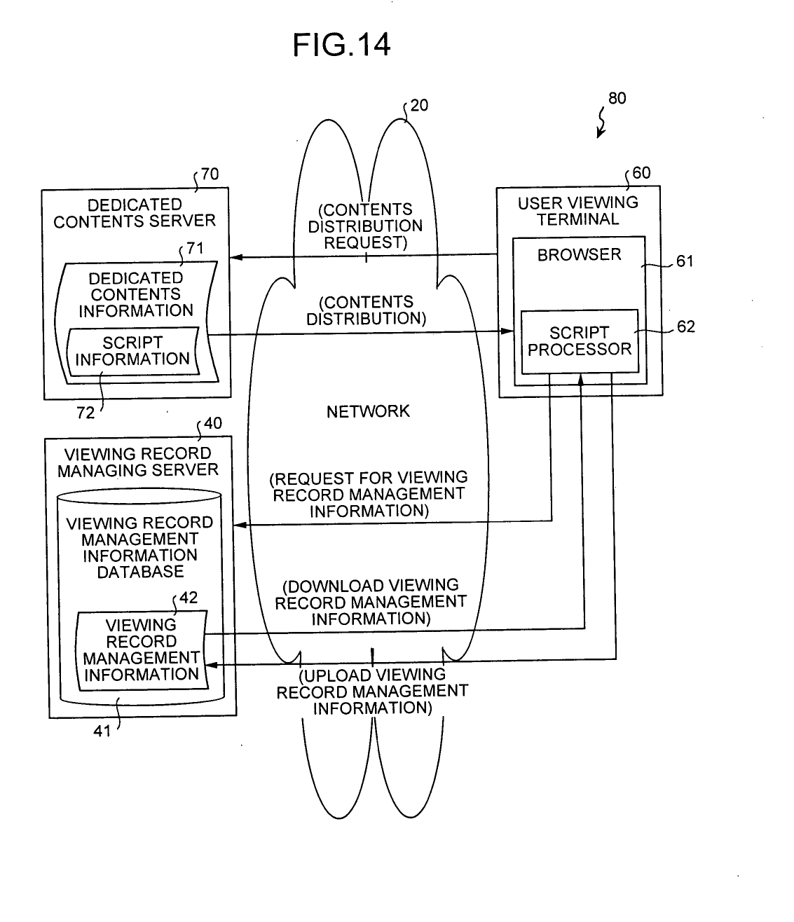

For example, the program for realizing the functions of the viewing record service server 400 and the viewing record managing server 500 may be recorded on a computer-readable recording medium 1000 shown in FIG. 12. A computer 900 shown in FIG. 12 may read the program recorded on this recording medium 1000 and execute the program to implement these functions.

The computer 900 shown in FIG. 12 includes a central processing unit (CPU) 910 that executes the program, an input device 920 such as a keyboard and a mouse, a read-only memory (ROM) 930 that stores various kinds of data, a random access memory (RAM) 940 that stores operation parameters, a reading device 950 that reads the program from the recording medium 1000, an output device 960 such as a display and a printer, and a bus 970 that connects between the sections.

The CPU 910 reads via the reading device 950 the program recorded on the recording medium 1000, and executes this program, thereby to implement the above functions. The recording medium 1000 includes an optical disk, a flexible disk, and a hard disk or the like.

According to the present invention, when a contents distribution request has been received from a user viewing terminal, the viewing record of the contents at this user viewing terminal is inquired to the external viewing record managing device. The contents obtained from the external contents distributing device is converted to the viewing-record reflected contents that reflects the viewing record. The viewing-record reflected contents are distributed to the user viewing terminal. Therefore, it is advantageously possible to carry out the online management of the add-on viewing records to the general-purpose contents, without using a dedicated browser or dedicated contents.

Moreover, the contents are converted into the viewing-record reflected contents so that viewing the contents is started from the viewing end position. Therefore, it is advantageously possible to start viewing the contents from the last viewing end position at the user viewing terminal, without using a dedicated browser or dedicated contents.

Furthermore, the contents are converted into the viewing-record reflected contents having the function of allowing viewing of the contents to be started from the bookmark position. Therefore, it is advantageously possible to start viewing the contents from the bookmark position at the user viewing terminal, without using a dedicated browser or dedicated contents.

Moreover, the contents are converted into the viewing-record reflected contents having the function of registering into the viewing record managing device the viewing end position at which the user ends viewing the viewing-record reflected contents. Therefore, it is advantageously possible to make the viewing record managing device carry out the online management of the viewing record (viewing end position) of the contents, without using a dedicated browser or dedicated contents.

Furthermore, the contents are converted into the viewing-record reflected contents that include the banner advertisement having a high relevance to either the contents or the user. Therefore, it is advantageously possible to utilize this system as the advertisement distributing system that realizes one-to-one marketing.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer program for servicing a viewing record of contents, the computer program making a computer execute:
receiving a distribution request for contents from a viewing terminal on a user side;
inquiring an external viewing record managing device about a viewing record of the contents at the user-side viewing terminal, when the distribution request is received;
obtaining the contents from an external contents distributing device;
converting the contents obtained into viewing-record reflected contents that reflect the viewing record; and
distributing the viewing-record reflected contents to the user-side viewing terminal.

2. The computer program according to claim 1, wherein
the viewing record includes a viewing end position last time at which viewing of the contents is ended, and
the converting includes converting the contents into viewing-record reflected contents so as to allow a user to start viewing the contents from the viewing end position.

3. The computer program according to claim 1, wherein
the viewing record includes a bookmark position marked by a user during viewing the contents last time, and
the converting includes converting the contents into viewing-record reflected contents having a function of allowing the user to start viewing the contents from the bookmark position.

4. The computer program according to claim 1, wherein
the converting includes converting the contents into viewing-record reflected contents having a function of adding a bookmark position to the viewing-record reflected contents while a user is viewing the viewing-record reflected contents, and a function of registering the bookmark position into the viewing record managing device as a viewing record.

5. The computer program according to claim 1, wherein
the converting includes converting the contents into viewing-record reflected contents having a function of registering a viewing end position last time at which viewing the viewing-record reflected contents is ended, into the viewing record managing device.

6. The computer program according to claim 1, wherein
the converting includes converting the contents into viewing-record reflected contents that include a banner advertisement having a high relevance to either of the contents and a user.

7. The computer program according to claim 6, making the computer further execute:
selecting a banner advertisement of a genre corresponding to distribution-requested contents from among a plurality of banner advertisements, wherein
the converting includes converting the contents into viewing-record reflected contents that include the banner advertisement selected at the step of selecting the banner advertisement.

8. The computer program according to claim 7, wherein
the viewing record includes a user preference, and
the selecting includes selecting a banner advertisement of a genre corresponding to the user preference in place of the genre corresponding to the contents, from among the banner advertisements.

9. The computer program according to claim 7, wherein
the viewing record includes a number of times of viewing the contents, and
the selecting includes selecting a banner advertisement of a genre corresponding to the contents that the user has viewed by a largest number of times in place of the genre corresponding to the contents, from among the banner advertisements.

10. An apparatus that services a viewing record of contents, the apparatus comprising:
a distribution request receiving unit that receives a distribution request for contents from a user viewing terminal;
a viewing record inquiring unit that inquires an external viewing record managing device about a viewing record of the contents at the user viewing terminal, when the distribution request receiving unit has received the distribution request;
a contents obtaining unit that obtains the contents from an external contents distributing device;
a converting unit that converts the contents obtained into viewing-record reflected contents that reflect the viewing record; and
a distributing unit that distributes the viewing-record reflected contents to the user viewing terminal.

11. The apparatus according to claim 10, wherein
the viewing record includes a viewing end position last time at which viewing the contents is ended, and
the converting unit converts the contents into viewing-record reflected contents so as to allow a user to start viewing the contents from the viewing end position.

12. The apparatus according to claim 10, wherein
the viewing record includes a bookmark position marked by a user during viewing the contents last time, and
the converting unit converts the contents into viewing-record reflected contents having a function of allowing the user to start viewing the contents from the bookmark position.

13. The apparatus according to claim 10, wherein
the converting unit converts the contents into viewing-record reflected contents having a function of registering a viewing end position last time at which viewing the viewing-record reflected contents is ended, into the viewing record managing device.

14. The apparatus according to claim 10, wherein
the converting unit converts the contents into viewing-record reflected contents that include a banner advertisement having a high relevance to either of the contents and a user.

15. A method of servicing a viewing record of contents, the method comprising:
receiving a distribution request for contents from a user viewing terminal;
inquiring an external viewing record managing device about a viewing record of the contents at the user viewing terminal, when the distribution request has been received;
obtaining the contents from an external contents distributing device;
converting the contents obtained into viewing-record reflected contents that reflect the viewing record; and
distributing the viewing-record reflected contents to the user viewing terminal.

16. The method according to claim 15, wherein
the viewing record includes a viewing end position last time at which viewing the contents is ended, and
the converting includes converting the contents into viewing-record reflected contents so as to allow a user to start viewing the contents from the viewing end position.

17. The method according to claim 15, wherein
the viewing record includes a bookmark position marked by a user during viewing the contents last time, and
the converting includes converting the contents into viewing-record reflected contents having a function of allowing the user to start viewing the contents from the bookmark position.

18. The method according to claim 15, wherein
the converting includes converting the contents into viewing-record reflected contents having a function of registering a viewing end position last time at which viewing the viewing-record reflected contents is ended, into the viewing record managing device.

19. The method according to claim 15, wherein
the converting includes converting the contents into viewing-record reflected contents that include a banner advertisement having a high relevance to either of the contents and a user.
